(19) United States
(12) Patent Application Publication
(10) Pub. No.: US 2024/0051280 A1
(43) Pub. Date: Feb. 15, 2024

(54) ENGINEERED BOND LAYER FOR METALLIZATION OF POLYMER AND COMPOSITE SUBSTRATES

(71) Applicant: University of Southern California, Los Angeles, CA (US)

(72) Inventors: Steven Nutt, Irvine, CA (US); Po-Lun Feng, Alhambra, CA (US)

(21) Appl. No.: 18/212,642

(22) Filed: Jun. 21, 2023

Related U.S. Application Data
(60) Provisional application No. 63/354,225, filed on Jun. 21, 2022.

(51) Int. Cl. B32B 27/14; B32B 27/08; B32B 27/20; B32B 33/00

(52) U.S. Cl. CPC B32B 27/14; B32B 27/08; B32B 27/20; B32B 33/00; B32B 2250/02; B32B 2255/205; B32B 2255/10; B32B 2260/02; B32B 2264/1058; B32B 2264/108; B32B 2264/20; B32B 2311/24

(57) ABSTRACT

Systems and methods to form a metallized polymer substrate including the steps of forming a bond layer on a surface of a polymer substrate, the bond layer comprising a hybrid structure of a polymer film layer and a metal component; bonding the polymer film layer to the surface of a carbon fiber reinforced polymer substrate; and depositing, by low-temperature metal spray deposition, a plurality of metal particles onto the bond layer.

### CROSS REFERENCE TO RELATED APPLICATIONS

This application claims priority to U.S. Provisional Appl. No. 63/354,225, entitled “ENGINEERED BOND LAYER FOR METALLIZATION OF POLYMER AND COMPOSITE SUBSTRATES” and filed on Jun. 21, 2022, which is herein incorporated by this reference in its entirety.

### TECHNICAL FIELD

Disclosed herein are systems, structures, and/or methods for enabling the metallization of polymer and composite substrates and, more particularly, a bond layer specifically engineered to facilitate the metallization of polymer and composite structures by cold spray deposition.

### BACKGROUND

Cold spray is a solid-state material consolidation process that typically involves micron-sized particles impinging on substrates at supersonic speeds and upon ballistic impact, undergo severe plastic deformation to fuse with the substrate. Metal-on-metal deposition has been widely studied and has been applied extensively to dimensional restoration and repair of metallic components (titanium, iron, aluminum, zinc, and engineering alloys) to extend service life, eliminate replacement costs, and reduce down time. The technique has also been used to apply wear-resistant coatings (i.e., CrC—NiCr, WC—CoNi), corrosion-resistant coatings (i.e., aluminum, zinc), electromagnetic interference shielding, and freeform additive manufacturing of net-shape parts. Cold spray has seen widespread use in military (missiles, submarines, ships), aerospace (aircraft), medical (antimicrobial, prosthetics), automotive, electronics, petrochemical, and nuclear industries.

Polymers and composites often are unable to meet design requirements because of weak impact and erosion resistance as well as insufficient electrical and thermal conductivity. Surface metallization can bestow metal-like durability for in-service conditions while retaining high strength-density ratio intrinsic to composites and polymers. Metallization of polymer composites would impart resistance to erosion and abrasion. Potential applications include leading edges of fan blades in turbine engines, wind turbine blades, thermal management to dissipate heat loads, and for rapid in-field repairs with minimal machining required post-spray.

Compared to conventional deposition techniques—electroless plating, chemical vapor deposition, and physical vapor deposition, cold spray affords substantial deposition rates and is not restricted by component dimensions. Among thermal spray techniques, cold spray operates at the lowest temperature and benefits from consolidating deposits with minimal heat-affected zones, undesirable phases, and oxidation. These characteristics permit cold spray to be uniquely compatible with thermally sensitive substrates—polymers and composites.

In the past decade, studies that have explored metal deposition by cold spray onto thermoset composites have underscored the risk of substrate erosion. Cold spray of Cu and Al particles erode the thermoset matrix and fracture the reinforcing fibers upon particle impact, preventing formation of a continuous, densified, and defect-free deposit. On the other hand, soft and ductile particles such as Sn tend to adhere only weakly to thermoset substrates.

It is, therefore, desired that systems and methods be developed to facilitate the use of metal deposition by cold spray with thermoset composites in a manner that avoids particle erosion or other undesired damage to the thermoset matrix or reinforcing fibers of the thermoset resin, thus enabling the metallization of such thermoset or polymer composites to would impart desired properties of erosion and abrasion resistance thereto.

This disclosure resolves these and other issues of the art.

### SUMMARY

The subject of this disclosure includes a hybrid, metal-polymer bond layer to reduce erosion and promote cold-welding of impinging powder in a low-temperature metal spray deposition process and/or system.

In some examples, a metallized polymer substrate is disclosed including a polymer substrate having a surface. A bond layer can be disposed on the polymer substrate surface, the bond layer a hybrid structure including a polymer component and a metal mesh layer. A metal layer disposed on the bond layer.

In some aspects, the polymer substrate is a carbon fiber reinforced polymer.

In some aspects, the polymer component is in the form of a polymer film that is disposed over the surface of the polymer substrate.

In some aspects, the polymer film includes a metal filler.

In some aspects, the polymer film layer is homogenous and the metal component is disposed over and in contact with the polymer film.

In some aspects, the metal layer includes metal particles disposed in the polymer film and on the bond layer wire mesh, wherein the metal particles include low-temperature metal spray depositioned Titanium particles.

In some aspects, the metal layer includes metal particles disposed in the polymer film and on the bond layer wire mesh, wherein the metal particles include low-temperature metal spray depositioned Nb and/or Ti-6A1-4V.

In some aspects, the metal mesh layer includes aluminum.

In some examples, a metallized polymer substrate is disclosed including a carbon fiber reinforced polymer substrate having a surface. A bond layer can be disposed on the polymer substrate surface, the bond layer including a hybrid structure of a polymer film layer and a metal component. The polymer film layer can be bonded to the surface of the carbon fiber reinforced polymer substrate. The metal component can be disposed on and bonded with the polymer film layer. A metal particles can form a metallized layer on the bond layer.

In some aspects, the bond layer polymer film layer includes a metal filler.

In some aspects, the metal component is woven wire mesh and the bond layer polymer film layer does not contain a metal filler.

In some aspects, the woven wire mesh is disposed over an entirety of the bond layer polymer film layer.

In some aspects, the woven wire mesh is disposed a partial depth into the bond layer polymer film layer such that a portion of the woven wire mesh is exposed a distance above a surface of the polymer film layer.

In some aspects, the metal particles of the metallized layer are disposed in the bond layer polymer film layer.

In some aspects, the metal particles of the metallized layer are disposed on the bond layer metal component.

In some aspects, a method is disclosed for forming a metallized polymer substrate including the steps of forming, based on an opening ratio between a mesh opening size of a metal component and a powder diameter of a plurality of metal particles, a bond layer on a surface of a polymer substrate, the bond layer comprising a hybrid structure of a polymer film layer and the metal component; bonding the polymer film layer to the surface of a carbon fiber reinforced polymer substrate; and depositing, by low-temperature metal spray deposition, the plurality of metal particles onto the bond layer.

In some aspects, the step of forming the bond layer includes selecting the polymer film layer and the metal component based on an opening ratio between a mesh opening size of the metal component and a powder diameter of the plurality of metal particles.

In some aspects, the opening ratio can be less than or equal to approximately 1.7.

In some aspects, the opening ratio ranges between approximately 1 to 3.

In some aspects, the opening ratio is defined by the mesh opening size being less than approximately ten times a mean powder diameter of the powder diameter of the plurality of metal particles.

In some aspects, the step of forming the bond layer includes selecting the polymer film layer and the metal component based on a diameter ratio of a powder diameter of the plurality of metal particles and a wire diameter of the metal component.

In some aspects, the step of forming the bond layer includes selecting the polymer film layer and the metal component based on based on a ratio of a powder diameter of the plurality of metal particles and a mesh opening diameter of the metal component.

In some aspects, during the step of forming the bond layer, the polymer film layer is disposed on the surface of the carbon fiber reinforced polymer substrate, the metal component being disposed on the surface of the polymer film, and the bond layer is subjected to a curing operation.

In some aspects, the polymer film layer does not contain a metal filler.

In some aspects, during the step of forming the bond layer, a wire component of the metal component is partially disposed or embedded in the polymeric film layer such that a portion of the wire component remains exposed above a surface of the polymeric film layer, wherein the step of depositing the plurality of metal particles onto the bond layer includes absorbing, by woven wires of the metal component, impact energy thereby reducing fracture or degradation of the polymer film layer.

In some aspects, the metal component of the hybrid bond layer is a wire mesh, and wherein during the step of depositing, the plurality of metal particles applied by low-temperature metal spray deposition are disposed onto the bond layer wire mesh.

In some aspects, during the step of depositing, the metal particles applied by low-temperature metal spray deposition are disposed into the polymer film layer.

To the accomplishment of the foregoing and related ends, certain illustrative aspects are described herein in connection with the following description and the appended drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1 is a schematic cross-section of a gas turbine engine, in accordance with various embodiments.

FIG. 2A is a perspective view of an example low-temperature metal spray deposition onto a carbon fiber reinforced polymer (CFRP), which is shown as a turbine fan blade that is a part of the turbine engine of FIG. 1.

FIG. 2B is a close-up view of section 2B of FIG. 2A showing exemplary low-temperature metal spray depositioned titanium coating of the CFRP.

FIG. 3A shows a perspective view of a section of an exemplary metallized polymer substrate according to one example.

FIG. 3B shows an exploded schematic overview of low-temperature metal spray deposition onto an example substrate according to aspects of this disclosure.

FIG. 4A illustrates aspects of bond layer substrates where an exemplary hybrid bond layer is reinforced with an exemplary wire mesh embedded in an epoxy film adhesive with metal filler.

FIG. 4B illustrates aspects of a supported mesh layer being low-temperature metal spray depositioned according to certain aspects of this disclosure.

FIG. 4C illustrates aspects of a supported mesh layer being low-temperature metal spray depositioned according to certain aspects of this disclosure.

FIG. 5 illustrates a side-cross sectional view of an exemplary metallized polymer substrate according to aspects of this disclosure.

FIG. 6A is a table showing exemplary content adjustment information from a first example related to Al filler (g/cm2).

FIG. 6B shows close-up views of exemplary wire mesh types used in the first example.

FIG. 7 is a table showing exemplary material properties and Johnson-Cook parameters of aspects of the first example.

FIG. 8A shows a chart showing thickness per pass results of the first example.

FIG. 8B shows a chart showing thickness per pass results of the first example.

FIG. 9A shows a close-up of powder deposited onto Al wires and eroded mesh openings of the first example.

FIG. 9B shows a close-up cross sectional view of the bond layer after a single pass of low-temperature metal spray deposition powder conformed to a round wire surface with a clear interface outline from the first example.

FIG. 9C shows a close-up cross sectional view of the bond layer after a single pass of low-temperature metal spray deposition powder conformed to a round wire surface with a clear interface outline from the first example.

FIG. 10 shows a close-up of the bond layer after two passes with particles filled in the eroded mesh openings forming a continuous layer of coating.

FIG. 11 shows close-up morphology of a round coating-bond layer interface of the first example.

FIG. 12 shows close-up morphology of a flat coating-bond layer interface of the first example.

FIG. 13 is a table showing exemplary bond layer specifications from a second example.

FIG. 14 is a table showing exemplary material parameters and properties from the second example.

FIGS. 15A to 16B show images of low-temperature metal spray deposition deposits produced with different bond layer designs according to the second example.

FIGS. 17A to 17D show images of deposition onto mesh wires and erosion of wire edges after 6-pass LTS onto a supported 50×50 according to the second example.

FIG. 18A to 19B show the images of finite element model simulations of deposition and degree of erosion of the mesh wire at different impact angles according to the second example.

FIG. 20 shows a comparison chart of the temporal evolution of plastic dissipation energy based on simulated impact angles according to the second example.

FIGS. 21A through 21D show close-up images of aspects of the second example showing the effects of opening ratio and diameter ratio on mechanical interlocking and wire separation in the hybrid bond layer.

FIGS. 22A and 22B show close-up cross-sectional images of simulations of the effects of opening ratio on mechanical interlocking in multiple particle simulations according to the second example.

FIG. 23A show a micrograph of BL20 according to the second example.

FIG. 23B show a line scan of the example of FIG. 23A according to the second example.

FIG. 23C show another line scan of the example of FIG. 23A according to the second example.

FIG. 23D show a map of Ti of FIG. 23A according to the second example.

FIG. 23E show a map of Al of FIG. 23A according to the second example.

FIG. 23F show a map of O of FIG. 23A according to the second example.

FIG. 24A show a micrograph at 400 substrate tilt according to the second example.

FIG. 24B show a micrograph at 400 substrate tilt according to the second example.

FIG. 24C show a micrograph at 0° substrate tilt according to the second example.

FIG. 24D show a micrograph at 400 deposit tilt according to the second example.

FIG. 25 illustrates a flowchart for a method, according to an embodiment.

### DETAILED DESCRIPTION

Disclosed herein is a bond layer that has been specially engineered for use with polymer and composite substrates to enable substrates containing the same to be metallized, e.g., by the cold-weld of impinging particles applied for example by cold spray deposition process. In an example, the bond layer is engineered having a metal-polymer hybrid structure that operates to reduce erosion of thermoset composites while facilitating the cold-weld of impinging metal particles. In an example, the hybrid bond layer is a combination of a metal component in the form of wire mesh, e.g., woven wire mesh, that is drapable and has openings for mechanical interlocking but prevents erosion of the substrate, with a polymer binder compatible with the polymer or composite substrate and cold-sprayed coating. In an example, the bond layer polymer film layer comprises metal filler, such as aluminum or the like, and the metal component may be formed from aluminum. The bond layer can be applied to polymer and composite substrates through co-curing or secondary bonding, which makes it compatible with conventional manufacturing processes for polymer and composite substrates.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

It must also be noted that, as used in the specification and the appended claims, the singular forms “a,” “an” and “the” include plural referents unless the context clearly dictates otherwise. By “comprising” or “containing” or “including” it is meant that at least the named compound, element, particle, or method step is present in the composition or article or method, but does not exclude the presence of other compounds, materials, particles, method steps, even if the other such compounds, material, particles, method steps have the same function as what is named.

In this disclosure, relative terms, such as “about,” “substantially,” or “approximately” are used to indicate a possible variation of 10% in the stated value.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the disclosed technology. Similarly, it is also to be understood that the mention of one or more components in a device or system does not preclude the presence of additional components or intervening components between those components expressly identified.

In an example, the bond layer polymer film layer is applied to a surface of the polymer or composite substrate to be metallized, and the hybrid bond layer metal wire mesh is disposed over the polymer film layer. In an example, the metal wire mesh is disposed over the entirety of the area to be metallized, e.g., over the entirety of the polymer film layer. In an example, the metal wire mesh is disposed a partial depth into the polymer film layer so that a portion of the metal wire mesh remains exposed above a surface of the polymer film layer.

The bond layer as disclosed herein offers the advantages of enabling cold spray deposition of metal particles, such as titanium or the like, onto polymer and composite substrates, effectively mitigating the mismatch of disparate properties of the deposit and the substrate, while preventing damage to and preserving the integrity of the underlying polymer-based substrate. Metallization of polymers and composites without substrate erosion during cold spray deposition is desired to achieving adhesive strength sufficient for service loads.

Use of metal wire mesh (woven or perforated) in the hybrid bond layer provides metal surfaces for metallic bonding and openings for mechanical interlocking of cold-sprayed particles. A ratio of particle diameter to mesh opening size is desired for obtaining such interlocking of particles and preventing substrate erosion. The continuous metal wires allow severe plastic deformation for metallic bonding and protect the substrate from erosion. The weave configuration of the wire mesh provides drapability to conform to contoured substrate geometries and also provides an increased surface area for adhesive bonding, interlocking, and metallic bonding.

In an example, the hybrid bond layer also functions to provide a transition, e.g., a thermal transition structure, between the substrate and the deposit, which have different coefficients of thermal expansion, thereby operating to mitigate the thermal property differences between the substrate and the metallized layer.

In an example, the polymer film layer or component of the hybrid bond layer adhesively bonds both to the substrate and to the woven mesh. During metallization, e.g., by cold spray deposition, impingement of the metal particles onto the hybrid bond layer causes partial erosion and roughening of the polymer matrix, which is desired for the purpose of bonding the cold sprayed coating to the substrate.

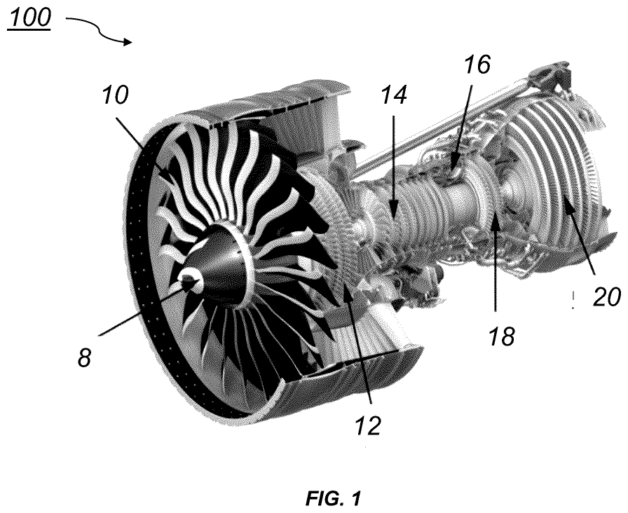

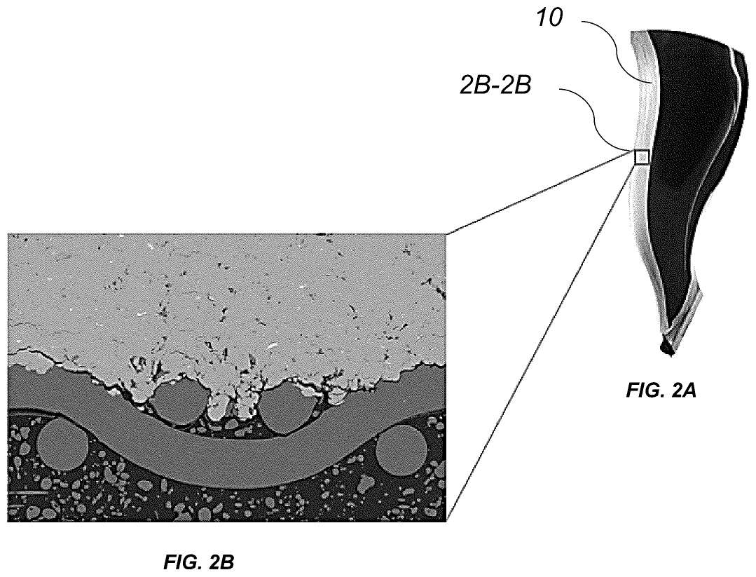

In some aspects, this disclosure is directed to methods and systems that include a hybrid metal-polymer bond layer designed and demonstrated for low-temperature metal spray deposition of metal onto carbon fiber reinforced polymers (CFRP). Thermosets and CFRPs undergo erosion by impinging powder and do not readily bond with metal. Polymers and composites often fail to meet design requirements because of poor resistance to impact and erosion, as well as poor electrical and thermal conductivity. In some aspects, the solution of this disclosure can include surface metallization, which can impart metal-like durability while retaining the high strength-density ratio intrinsic to composites and polymers. In particular, metallization of polymer composites of this disclosure can impart resistance to erosion and abrasion. Potential applications include leading edges of turbine engine fan blades, as shown in FIGS. 1 and 2A-2C as well as numerous other applications, such as wind turbine blades, thermal management to dissipate heat loads, and in-field repairs.

Turning to the drawings, FIG. 1 is a schematic cross-section of a gas turbine engine 100, in accordance with various embodiments. The example engine can include a spinner section 8, a fan section with a plurality of fan blades 10, a low pressure compressor 12, a high pressure compressor 14, a combustor 16, a high pressure turbine 18, and a low pressure turbine 20. Although FIG. 1 includes an exemplary depiction of a gas turbine engine, it should be understood that the concepts described herein are not limited to use with only turbine engines as the teachings may be applied to other applications, including but not limited to other types of turbine engines including turbojet, turboprop, turboshaft, power generation turbines, with or without geared fan, geared compressor or three-spool architectures, leading edges of turbine fan blades and wind turbine blades, lightning protection for composite aircraft, light weighting in automotives, sporting goods, automotive parts, and/or the like.

FIG. 2A is a perspective view of an example low temperature metal spray deposition onto a carbon fiber reinforced polymer (CFRP), which is blade 10. In this disclosure, the term “low-temperature metal spray deposition” or “LTS” can include cold welding techniques including metallization methods, explosion welding, magnetic pulse welding, as well as cold spray deposition which can be a high-energy solid-state powder deposition and consolidation process to produce a coating as well as other low temperature powder spray techniques, including those that typically do not increase the substrate surface temperature to above approximately 200 degrees Celsius, in a manner so that the powder and substrate surface do not surpass a glass transition temperature of the respective polymer(s). FIG. 2B is a close-up view of section 2B of FIG. 2A showing exemplary low-temperature metal spray depositioned titanium coating of the CFRP of the blade of FIG. 2A. In some aspects, certain aspects of the low-temperature metal spray deposition of metal particles that include titanium can be selectively varied and/or optimized, including parameters such as impact angle, distance, temperature, particle diameter, spray velocity, and/or mesh opening of the metal layer of the hybrid substrate associated with the CFRP (e.g., of blade 10 being restored or otherwise serviced in accordance with aspects of this disclosure).

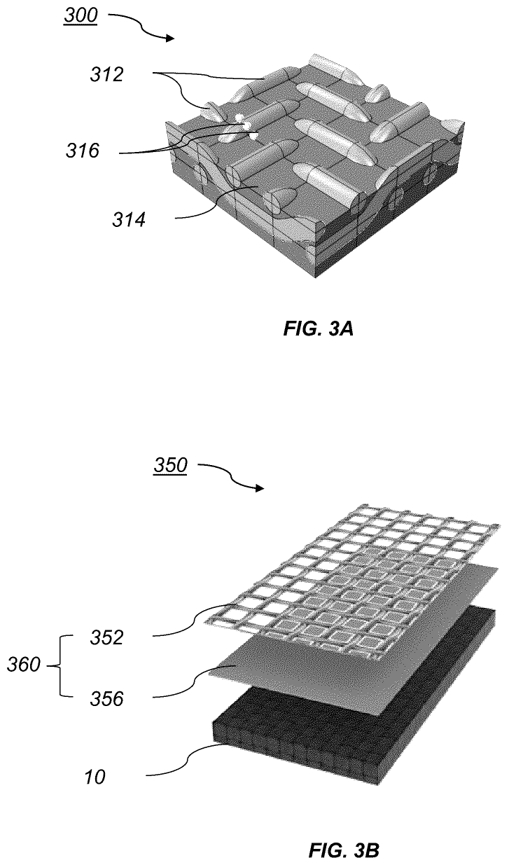

FIG. 3A shows a perspective view of a section 300 of an exemplary metallized polymer substrate according to one example. As can be seen, section 300 includes a polymer substrate layer 314 and a metal layer (e.g., Al mesh) 312 with a powder coating layer 316 disposed on each of layers 314 and 312. Most preferably, the powder coating layer 316 includes metal particles that include Ti (e.g., Ti-6A1-4V). However, other powder coating materials are contemplated for use with layer 316, as needed or required, including but not limited to metal powders that include Al, Zn, Cu, NisAl, and/or the like. In some aspects, compared to examples where the powders include Ti, Nb, and/or Ti-6A1-4V, it has been found that use of Al and Zn can exhibit less strength and are more easily deformed for reduced CFRP erosion during LTS deposition.

The mesh layer 312 shown in FIG. 3A is Al 120×120 and is merely exemplary and other meshes, including different materials, thicknesses, and weave patterns are contemplated for use as layer 312. Section 300 can be produced in any number of low-temperature metal spray deposition techniques. For example and without limitation, in some aspects the section 300 can be co-cured with the CFRP (e.g., blade 10) bond layer (e.g., Al-epoxy bond layer) using a cure cycle, and then low-temperature metal spray depositioned.

FIG. 3B shows an exploded schematic overview of low-temperature metal spray deposition process 350 onto an example substrate 10 (e.g., in the process of repairing and/or restoring and/or servicing blade 10 from FIG. 1) according to aspects of this disclosure. In FIG. 3B, the hybrid polymer metal bond layer (BL) 360 is formed by the metal layer 352 and film layer 356. Bond layer 360 is formed via low-temperature metal spray deposition deposited thereon (e.g., particle size (D90) of sprayed CP Al: 58 m, CP Ti: 40 m). In some aspects, BL 360 can include an epoxy film adhesive with aluminum powder filler (LOCTITE EA 9658 AERO), film adhesive and aluminum wire cloth, 50×50 mesh (BL-50R), 120×120 mesh —Round and Flat Wires (BL-120R, BL-120F), 200×200 mesh (BL-200R), and/or the like. In some aspects, film layer 360 includes epoxy reinforced by continuous metal wires of a mesh of the metal layer 352 and does not include any dispersed filler particles (e.g., particles of Al). In some aspects, the CFRP of substrate 10 can include Toray 2510 out-of-autoclave prepreg —spread tow, plain weave, 10 plies. In some aspects, the LTS parameters can be CP Al—He, 400° C., 2 MPa; CP Ti—He, 200° C., 2.8 Mpa. In some aspects, woven wires of layer 352 absorb and dissipate impact energy of LTS powder of particles (e.g., those of layer 316 shown in FIG. 3A) thereby preventing degradation or fracture of film layer 356. In some aspects, aspects of the LTS operations with respect to particles of layer 316 included multiple LTS passes. For example and without limitation, a second LTS pass after a first LTS pass can be used to fill previously eroded regions of the bond layer with LTS powder to form a continuous deposit layer thereon. The deposit layer of layer 316 can be extended into previously eroded regions, effectively anchoring the coating of in the bond layer via a tortuous coating-substrate interface.

In some aspects, the BL 360 is formed by selecting the film layer 356 and metal particles sprayed thereon (e.g., layer 316) based on an opening ratio between a mesh opening size of the metal layer 352 and a powder diameter of the metal particles. In some aspects, the opening ratio can range between approximately 1 to 3. In some aspects, the opening ratio can be less than or equal to approximately 1.7. In some aspects, the BL 360 is formed by selecting the film layer 356 and metal particles sprayed thereon (e.g., layer 316) based on a diameter ratio of a wire diameter of metal layer 352 and a powder diameter of the metal particles. In some aspects, a powder diameter to a wire diameter ratio can be approximately 1:5. In some aspects, a ratio of a powder diameter to mesh opening diameter can be approximately 1:3.

In some aspects, the opening ratio used can be defined by the mesh opening size being less than approximately ten times a mean powder diameter of the powder diameter of the plurality of metal particles.

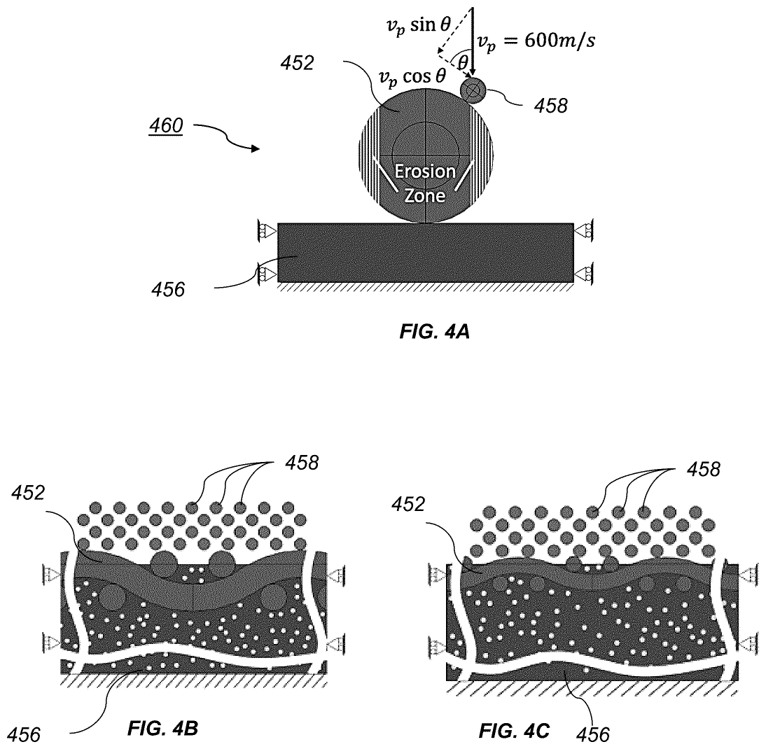

FIG. 4A illustrates aspects of bond layer substrates where an exemplary hybrid bond layer 460 is shown reinforced with an exemplary wire mesh 452 embedded in an epoxy film adhesive layer 456 with metal filler with simulated impact of a single particle (e.g., a Ti particle) onto supported mesh 452. Here, layer 460 and the corresponding CFRP can be co-cured in a vacuum-bag only (VBO) process. Mesh 452 can be was positioned atop layer 456 (e.g., an epoxy substrate) with contact defined between mesh 452 and layer 456. To decouple the effects of the layer 456 and the mesh 452 on deposit adhesion, supported mesh 452 (FIG. 4B) was also low-temperature metal spray depositioned according to a second example, discussed more particularly below, to investigate interactions between Ti powder and Al wire. FIGS. 4B and 4C illustrate the impact of multiple particles 458 distributed in an alternating grid arrangement impinging onto the respective mesh 452, where FIG. 4A illustrates mesh 452 as BL120 and FIG. 4B illustrates mesh 452 as BL200. It is understood that any mesh is capable of being used as needed or required in the herein disclosed system and that the illustrations of FIGS. 4B and 4C are merely exemplary.

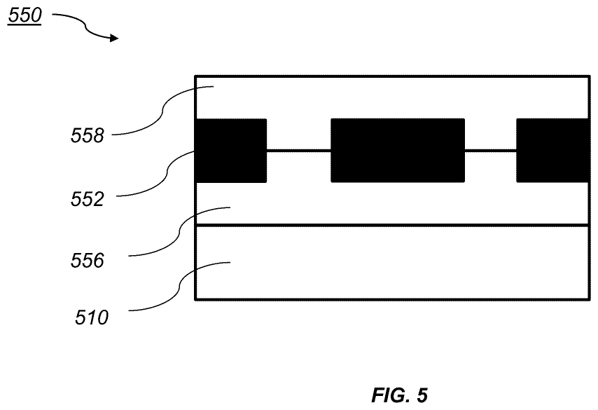

FIG. 5 illustrates a side-cross sectional view of an exemplary material layup of exemplary system 550 according to aspects of this disclosure. As can be seen and similar to previous examples, CFRP 510 includes adhesive layer 560 thereon with mesh layer 552 at least partially embedded therewith. Particles 558 as illustrated have been low-temperature metal spray depositioned on top of layer 552 and film adhesive layer 556. It is understood that the depicted layup is capable of being modified, adjusted, and/or including fewer or greater number of layers, as needed or required and that the illustration of FIG. 5 is merely exemplary.

### WORKING EXAMPLES

The following examples are intended to be purely illustrative, and not limiting.

### First Example

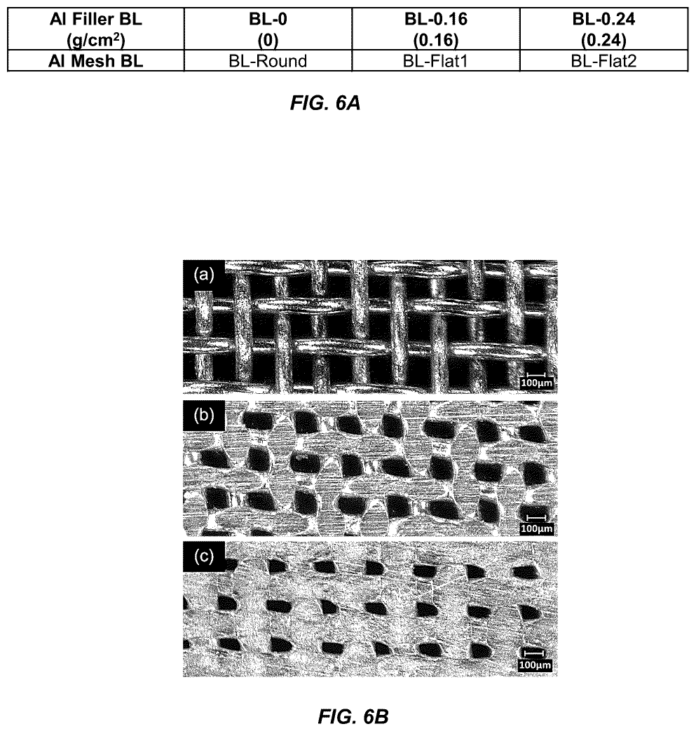

In a first example regarding bond layer preparation and low-temperature metal spray deposition, commercial purity Al powder (38.9±16.2 pm) was low-temperature metal spray depositioned (LTS) onto carbon fiber-reinforced polymers (CFRP) laminates with a hybrid metal-polymer bond layer (BL) on the surface. The CFRP consisted of ten plies (0/90) of prepreg (Toray 2510, Toray Industries, Inc., Tokyo, Japan). The reinforcements of the hybrid bond layer included Al filler particles and woven Al 5056 120×120 wire mesh (McMaster-Carr, Elmhurst, IL, USA) embedded in an epoxy film adhesive with Al filler (LOCTITE® EA 9658 AERO, Henkel, Dusseldorf, Germany). The content of Al filler (g/cm²) was adjusted as shown in FIG. 6A. FIG. 6B shows the 3 types of wire mesh—original with round wires (BL-Round) (view (a) of FIG. 6B), wires flattened once (BL-Flat1) (view (b) of FIG. 6B) and twice (BL-Flat2) (view (c) of FIG. 6B). The bond layer and CFRP were compacted and co-cured in an out-of-autoclave process. The substrate was then sprayed with He at 400° C., 2 MPa, and a stand-off distance of 25.4 mm.

Regarding microstructural characterization and lug shear test, the hybrid metal-polymer bond layer and the deposits were sectioned and polished, and the thickness of the bond layer was measured using light microscopy (VHX-5000, Keyence, Osaka, Japan). The samples were also ion polished (JEOL SM-09010, Tokyo, Japan) for SEM (Nova NanoSEM 450, Thermo Fisher Scientific, Waltham, MA, USA) imaging to investigate the microstructural evolution as a function of the number of LTS passes, using both plan and cross sections. The cross sections were used to calculate the root-mean-square (RMS) roughness of the interface between the deposit and BL along mesh wires. Lug shear strength of the deposit was measured according to MIL-J-24445A, and fracture surfaces were examined by SEM to determine the adhesion mechanism.

Turning to finite element analysis, calculations (ABAQUS/Explicit) simulated the high-velocity impact of Al powder on hybrid metal-polymer bond layers. The substrate models depicted the BL geometries and dimensions, and the powder were modeled as solid spheres. The impact simulation on the twill mesh was conducted in 3D (mesh type C3D4T, four-node thermally coupled tetrahedron, linear displacement and temperature). Contacts between the powder and the substrates were defined as surface-to-surface hard contact with a 0.3 coefficient of friction. In previous FIG. 3A, the three locations of powder impact are shown at the velocity of 650 m/s which was used.

In the example depicted previously in FIG. 3A, powder impact was assumed to be adiabatic with the inelastic heat fraction set to 0.9. The Johnson-Cook (JC) strain-rate dependence plasticity model was used to calculate yield stress and expressed as:

$${σ}_{f} = [ A + B {ε}_{p}^{n} ] [ 1 + C ln ( \frac{{\dot{ε}}_{p}}{{\dot{ε}}_{0}} ) ] [ 1 - {( \frac{T - {T}_{r}}{{T}_{m} - {T}_{r}} )}^{m} ]$$

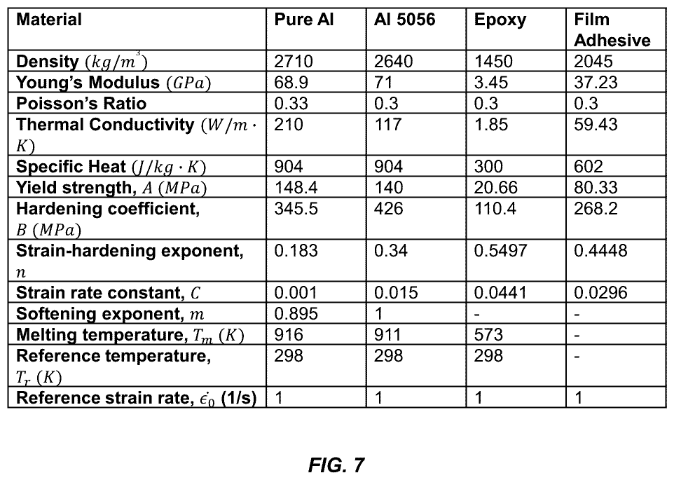

Johnson-Cook parameters for pure Al, Al 5056 and epoxy are listed in the table of FIG. 7. The film adhesive was assumed to be homogeneous, and its properties and JC parameters were calculated based on the rule of mixture of epoxy resin and aluminum. In conjunction with the Johnson-Cook plasticity model, a tensile failure model (ABAQUS/Explicit) was used to determine the fracture onset of film adhesive. Fracture occurs when the pressure stress exceeds the hydrostatic cut-off stress of 120 MPa.

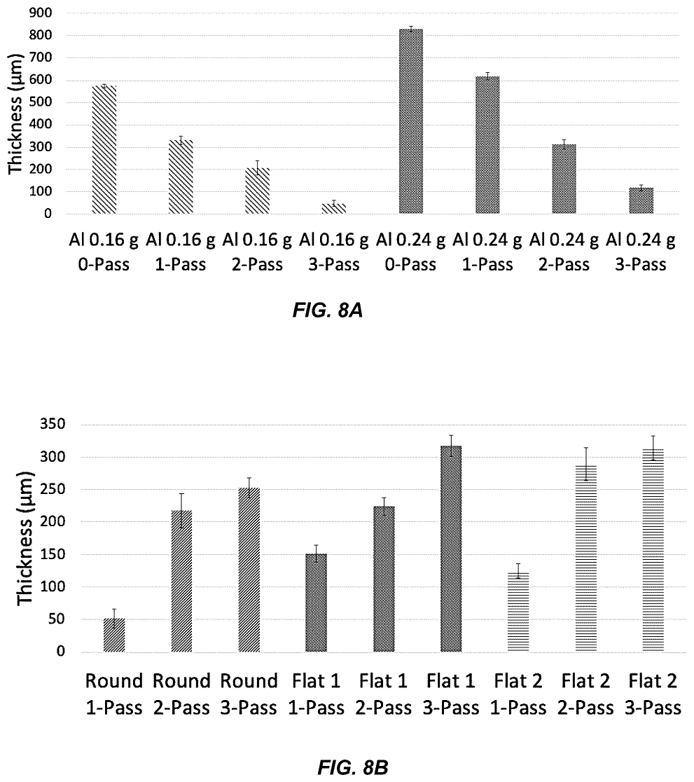

It was discovered that the dependence of deposit thickness on number of passes revealed competition between powder deposition and substrate erosion during the first three passes, as well as the dependence of deposition yield on BL design. FIG. 8A is a chart showing that epoxy reinforced by continuous metal wires, rather than dispersed filler particles of Al, was required for the metallization of CFRP. Regardless of any metal filler, the bond layer was consistently eroded, manifested by the reduction in bond layer thickness with increasing LTS passes. The eroded thickness ranged from 100-300 μm with no clear dependence on BL thickness or number of passes. Cracks repeatedly formed and propagated in the BL upon impingement of powder, causing detachment of filler and spallation of epoxy, leading to decreases in BL thickness. On the other hand, FIG. 8B shows deposit buildup for all three wire meshes, indicating that incorporation of continuous metal wires reduced erosion and promoted deposition. The woven wires absorbed and dissipated the impact energy of LTS powder, preventing degradation or fracture of the epoxy matrix. The metal wires also served as an effective substrate for metal-metal deposition. The first pass of BL-Round shows a coating thickness ˜100 μm less than the first pass coating thicknesses of BL-Flat1 and BL-Flat2. The difference indicated that the round metal wires caused greater erosion of the BL compared to flat metal wires. For subsequent passes, the deposition rates were comparable.

Finite element analysis of a single LTS powder impinging on Al filler embedded in the BL demonstrated the erosion mechanism. Two cases of impingement were investigated to describe and predict possible interactions between LTS powder and filler BL. When the powder directly impinged on filler embedded in epoxy, the filler was severely deformed and flattened. The stresses imposed caused crack formation in the surrounding regions. When the impact was on epoxy with filler in proximity, cracks propagated and debonded the filler from the surrounding epoxy matrix. With successive impacts, there was low probability for powder to accumulate on the filler BL. Isolated Al filler particle in an epoxy matrix did not sufficiently absorb LTS powder impacts, which prevented deposition.

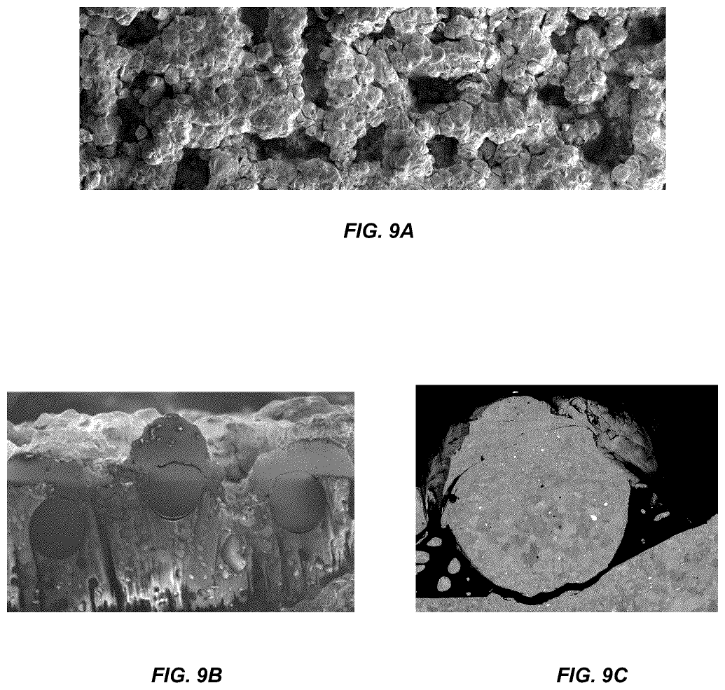

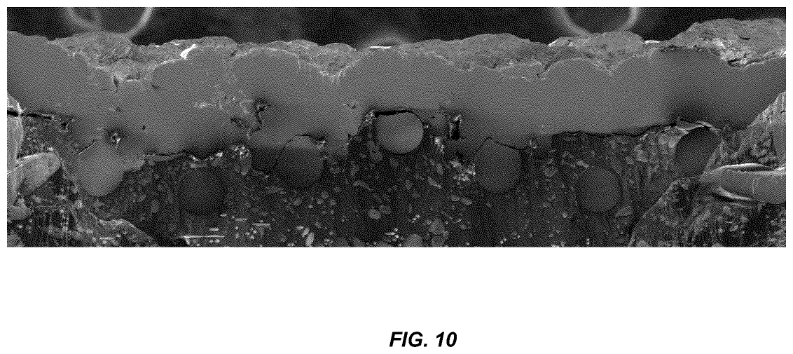

FIGS. 9A to 10 show the interactions from the first experiment as between LTS powder and the BL-Round during first and second passes. During the first pass, powder deposited onto Al wires and eroded mesh openings filled with epoxy, revealing a grid-like pattern analogous to a projection of the wire mesh (FIG. 9A). In certain regions, deposition was also observed between wires that bridged the wire openings filled with epoxy. In both cases of deposition, powder-powder bond lines were apparent because of the absence of peening. LTS powder completely covered and bonded loosely to the wires.

After a single pass, LTS powder conformed to the round wire surface with a clear interface outline between, as shown in FIG. 9B. The curved wire substrate presented difficulties for impinging powder because of the gradual change in impact angle. Nevertheless, during the first pass, metallic bonding was achieved, although limited and infrequent as shown in FIG. 9C. LTS powder were flattened and displayed fine grains, both caused by severe plastic deformation. The fine grains were also present at the top and bottom of the wire cross section, a consequence of deposition at a 900 angle.

The second pass filled the eroded regions with LTS powder and formed a continuous deposit. The deposit extended into previously eroded regions, effectively anchoring the coating in the bond layer via a tortuous coating-substrate interface, shown in FIG. 10. However, discrete interfacial cracks formed because of relatively weak bonding of powder on epoxy and the limited metallic bonding between powder and wires. Cracks were observed between Al wires and the epoxy matrix, which were attributed to debonding induced by LTS imposed stresses, and mismatch in coefficient of thermal expansion between Al and epoxy. Peening of powder at mesh openings was not sufficient to fully eliminate porosity.

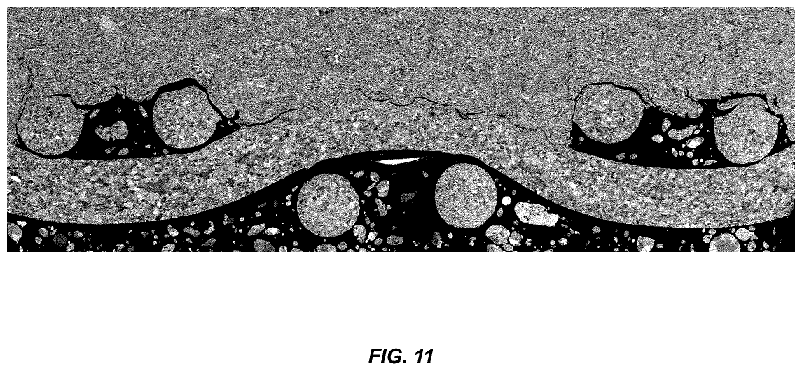

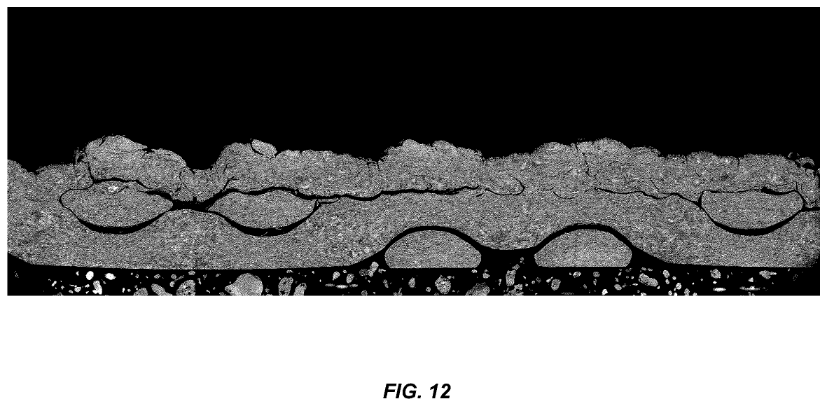

The morphology of the coating-BL interface depended primarily on mesh shape (round vs flat) as shown by the comparison of BL-Round and BL-Flat2 (FIG. 11 to 12). FIGS. 11 to 12 show that in both BL-Round (FIG. 11) and BL-Flat (FIG. 12), discrete cracks and intermittent metallic bonding were present. The cracks in BL-Flat were straight, while those in BL-Round were not. These cracks can be reduced/eliminated by adjustment of LTS parameters. The significant finding is that a relatively high aspect ratio as to width to height ratio of the wire cross section (3:1) and leveled surface of the flattened wires provided a relatively flat interface and an unobstructed/linear path for crack propagation.

The shear strength of BL-Round was 14.5±1.5 MPa, whereas the shear strength of BL-Flat1 and BL-Flat2 could not be measured because the coatings delaminated from the BL after LTS. The delamination was attributed to crack propagation through the coating-BL interface because of the absence of mechanical interlocking with the wire mesh and the flat interface. By the rule of mixture, interlocking in the 27% open area of the Al mesh yielded a maximum shear strength of 16.2 MPa with 60 MPa as the bulk pure Al shear strength. The 1.7 MPa difference was attributed to the incomplete bonding of powder in the mesh openings and can be reduced by adjusting LTS parameters.

### Second Example

In a second example regarding bond layer preparation and low-temperature metal spray deposition, hybrid bond layers were investigated with woven wire meshes and select opening sizes were embedded in an epoxy film adhesive to determine the effects of feature dimensions within the bond layer with respect to powder size on the metallization of carbon fiber reinforced polymer (CFRP) by LTS. In the second example, it was surprisingly revealed that selective arrangement of dimensional parameters led to fabrication of strongly bonded deposits on thermoset composites.

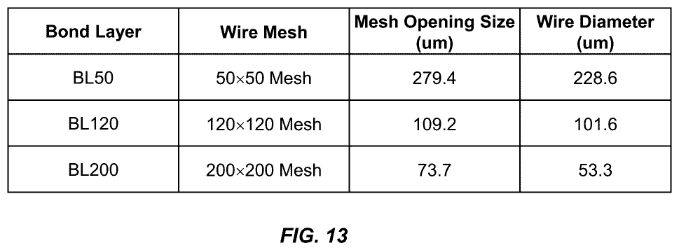

In the second example, commercial purity Ti powder (CP Ti, D90=40 pm, 325×325 mesh) was low-temperature metal spray depositioned onto a hybrid metal-polymer bond layer (BL) on the surface of a CFRP laminate (1.5 mm thick), comprised of ten plies (0/90) of prepreg (Toray 2510, Toray Industries, Inc., Tokyo, Japan). The second investigation investigated two types of bond layer substrates, including embedded mesh and supported mesh. The wire mesh was fully embedded in the film adhesive or positioned atop and supported by the film adhesive. The hybrid bond layer was reinforced with Al 5056 wire mesh (McMaster-Carr, Elmhurst, TL, USA) embedded in an epoxy film adhesive with Al filler (LOCTITE® EA 9658 AERO, Henkel, Dusseldorf, Germany). The bond layer and CFRP were co-cured in a vacuum-bag only (VBO) process following manufacturer's guidelines. To decouple the effects of the film adhesive and the metal mesh on deposit adhesion, supported mesh was also low-temperature metal spray depositioned to investigate interactions between CP Ti powder and Al wire. Three mesh opening sizes—BL50, BL120, and BL200—were investigated as described in the table of FIG. 13. The substrates were low-temperature metal spray depositioned with He at 200° C., 2.76 MPa, raster speed of 400 m/s, and a stand-off distance of 25.4 mm using a VRC Gen III CS system (VRC Metal Systems, Rapid City, SD, USA). The mean powder velocity of 594 m/s was measured at the nozzle exit using a laser velocimetry system (HiWatch HR1 CS, Oseir, Tampere, Finland).

In the second example, the hybrid metal-polymer bond layer and the deposits were sectioned and ion polished (JEOL SM-09010, Tokyo, Japan) for SEM (Helios G4 PFIB UXe, Thermo Fisher Scientific, Waltham, MA, USA) imaging to analyze both plan and cross sections. The supported mesh was cold mounted before sectioning and polishing for cross-sectional imaging. EDS (Ultim Max, Oxford Instruments, Abingdon, UK) maps and line scans were used to detect the presence of Ti, Al, and O. The largest powder diameter—44 pm, was used to calculate the opening ratio (mesh opening size to powder diameter) and the diameter ratio (wire diameter to powder diameter). Adhesive shear strength of the deposit (6-pass CP Ti followed by 30-pass CP Al) was measured according to MIL-J-24445A. The shear strength was calculated by taking the average of 5 measurements. The resulting fracture surfaces were examined by SEM to identify the adhesion mechanisms. Three mesh opening sizes—BL50, BL120, and BL200—were investigated as described in the table of FIG. 13.

In a finite element model simulation of the second example, similar to aspects previously shown in FIGS. 4A to 4C, a simulation demonstrated wire erosion upon impact, as the position of impinging powder particle varied along the wire cross section. The simulation demonstrated the impact of multiple Ti particles impinging onto BL120 and BL200, as previously shown in FIGS. 4B and 4C. This simulation depicted the impact load transferred to the wire mesh and the accumulation of LTS powder at the mesh openings. In this simulation, all the particles traveled at the same impact velocity as the measured in-flight velocity. As previously shown in FIGS. 4B and 4C, the particles were distributed in the same alternating grid arrangement for both BL120 and BL200 to reflect the different deposition behaviors on the bond layers. In the simulation, 58 particles in total accumulated to two particle layers for comparison with experimental results.

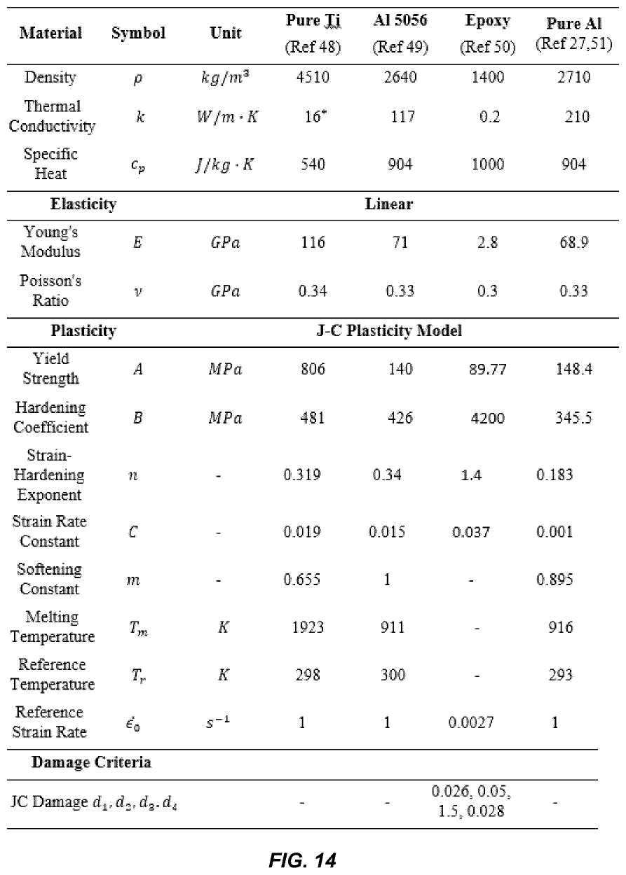

In both simulations, the Johnson-Cook (JC) model was used to simulate plasticity of the material. The erosion of epoxy in multiple particle impact was simulated using the Johnson-Cook damage criterion. The material parameters and properties used are listed in the table of FIG. 14. The simulated impact velocity was 600 m/s, which was chosen based on the measured powder velocity (593.8 m/s), and the initial temperature was set to 298K. The simulation grid size was 1/50dₚ for single particle impact, and 1/20dₚ for multiple particle impact. A coarser grid size was selected for the multiple particle simulations because of the larger computational resources compared to the single particle model. The element type was CPE4RT with reduced integration and hourglass control.

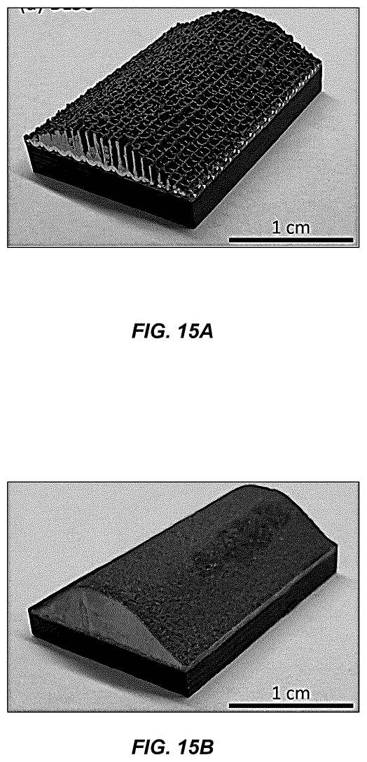

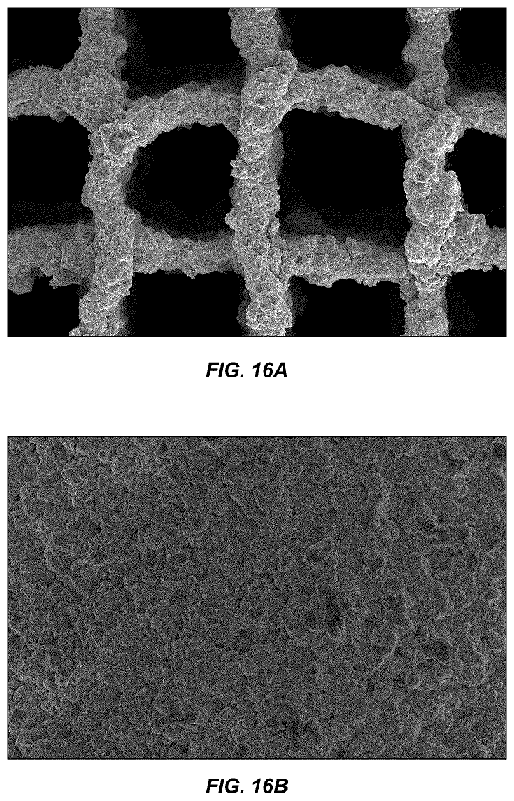

FIGS. 15A to 16B show images of LTS deposits produced with different bond layer designs. The images show that the continuity and structure of the deposit depended on the selected opening ratio (mesh opening size to powder diameter) and the pattern of the underlying mesh. An opening ratio of 6.4 (BL50) produced a discontinuous structure (FIGS. 15A and 16A), while a ratio of 1.7 (BL200) yielded a continuous coating (FIGS. 15B and 16B). FIGS. 15A and 16A display vertically consolidated, thin-walled grid patterns with open microchannels on the 50×50 mesh. The sprayed microchannels replicated the weave topography of the mesh, and no excess powder fused to the sides of the walls. The finding indicates that the underlying mesh can serve as a template for additive manufacturing of upright micro-scale structures with thin walls (˜150 um). FIGS. 15B and 16B show a continuous and densified deposit on BL200. No porosity or cracks are evident in the plan view in FIG. 16B.

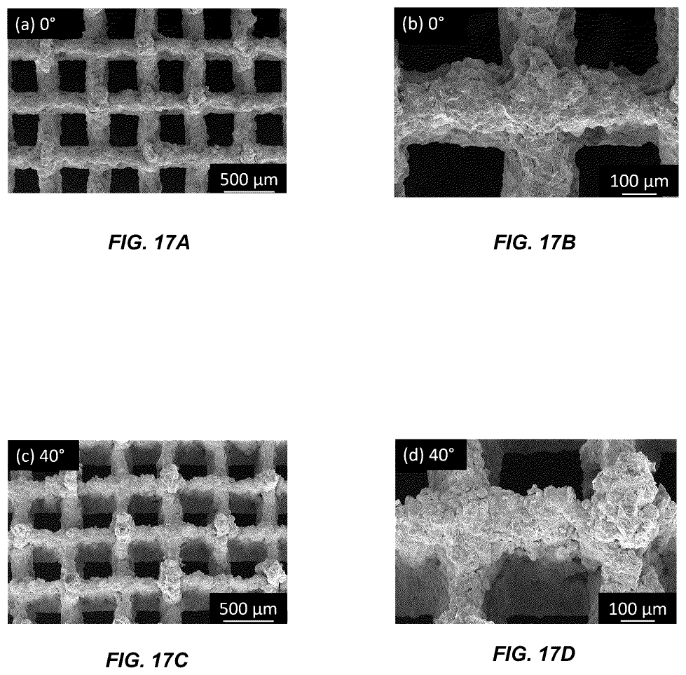

Images in FIGS. 17A to 17D show deposition onto mesh wires and erosion of wire edges after 6-pass LTS onto a supported 50×50 mesh (opening ratio: 6.4, diameter ratio: 5.2). The grid pattern of the wire was preserved, resulting in rectangular openings (FIG. 17A). The wire edges yielded no deposit and formed erosion zones at impact angles <450 (calculated using FIGS. 17A and 17B. FIGS. 17C and 17D support this description and present a similar observation when the sample is viewed after tilting to 40°. The images display vertically stacked CP Ti powder at the center of the wires with steeply inclined sides. Powder consolidated only in the vertical direction, while no powder fused to the sides of the wire or deposit. The formation of a discontinuous structure was a function of both the opening ratio and the impact angle. The eroded regions of wires increased the effective opening ratio by widening the mesh opening required for powder to bridge and form a continuous deposit.

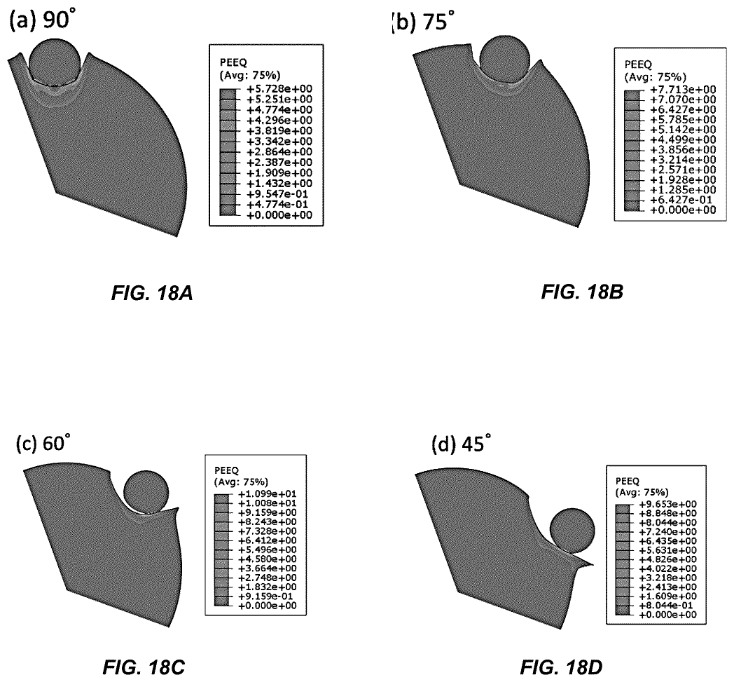

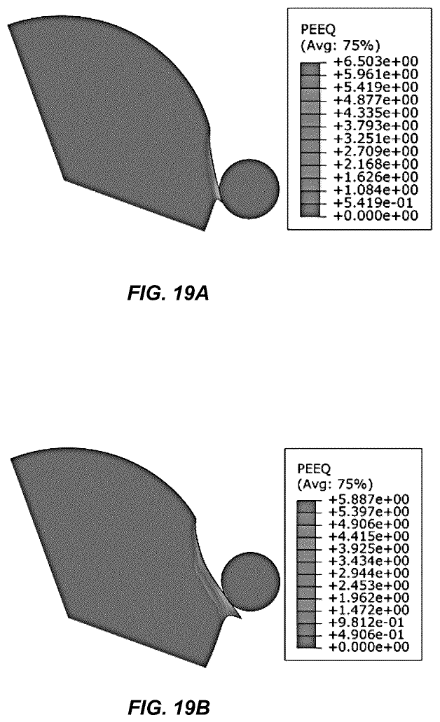

FIGS. 18A to 19B show the deposition and degree of erosion of the wire at different impact angles. The total simulation time was 500 ns, and each image was captured immediately after the equivalent plastic strain (PEEQ) became constant over time. Deposition and erosion of the wire at a 90° spray angle depended on the local impact angle of impingement, as depicted in FIGS. 18A to 19B. Local impact angles greater than 45° led to cratered mesh wire around the impact site (FIGS. 18A to 18C). However, impact angles less than or equal to 45° led to severe plastic deformation of the wire periphery, causing erosion (FIGS. 18D to 19B). The velocity of the impinging particle can be decomposed into the normal component (vₚ sin θ) and the tangential component (vₚ cos θ). For impact sites at increasing distances from the wire center, the impact angle decreased. Correspondingly, the normal impact velocity reduced by a multiple of sin θ, reducing the crater depth and resulting in insufficient deformation for bonding. In concurrence, the tangential momentum elongated the crater and facilitated particle rebound. The progressively shorter crater rim failed to capture and retain subsequently impinging particles.

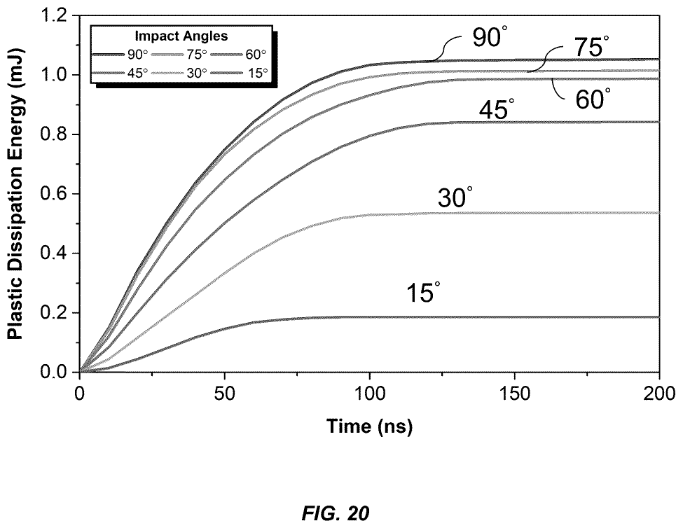

Similar conclusions can be drawn from analysis of the kinetic energy of the impinging particle, which transformed into friction dissipation, plastic dissipation, and recoverable strain energies. A greater plastic dissipation energy (ALLPD variable in Abaqus) from the induced kinetic energy (ALLKE) correlated with the adhesion energy, e.g., the probability of particle bonding to the substrate. Temporal evolution of plastic dissipation energy based on simulated impact angles are compared in FIG. 20. Plastic dissipation energy decreased in conjunction with the impact angle. At impact angles less than 45°, the plastic dissipation energy was less. These findings were consistent with studies where impact angles less than 45-60° for various material combinations yielded negligible deposition.

In the second example, it was observed that tamping by subsequently impinging powder did not effectively fuse powder above the mesh to powder directly on the film adhesive. The observation indicates that for embedded BLs, deposit adhesion depended at least partially on wire attachment to the BL matrix.

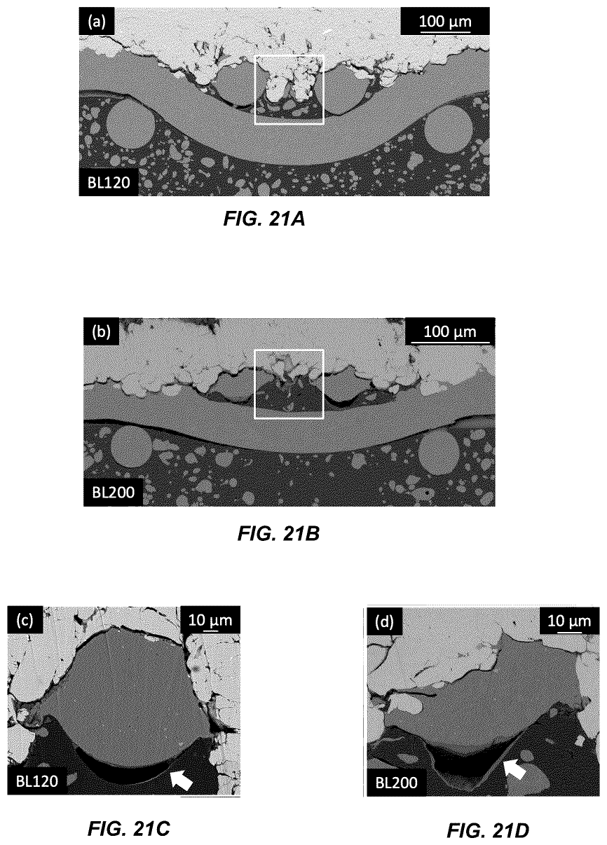

FIGS. 21A through 21D show the effects of opening ratio and diameter ratio on mechanical interlocking and wire separation in the hybrid bond layer. Specifically, FIG. 21A shows ˜85 μm powder embedment in the area surrounded by three wires, framed in white. The sample (BL120, opening ratio 2.5), shows two parallel wires present top center, and one serpentine wire crossing beneath. In contrast, FIG. 21B shows ˜30 μm powder embedment in a similar region for BL200 (opening ratio 1.7). At the mesh opening, loosely bonded powder was observed (white frame), a result of detachment during sample preparation. The contribution of interlocking to adhesive strength would increase with embedment depth if the deposit extending into wire openings were fully consolidated, as demonstrated with CP Al in a previous study. However, the chosen CS parameters in this work yielded loosely bonded powder that was inadequately interlocked. For wires not in mutual contact, the separation distance from the epoxy matrix depended on the diameter ratio. FIGS. 21C to 21D show separation distances of 11 μm and 19 μm for diameter ratios of 2.3 and 1.2 (BL120 vs BL200). Additionally, FIG. 21D shows a thin layer of Al wire that remained attached to epoxy at the bottom of the gap, a phenomenon attributed to oxidation, as discussed below.

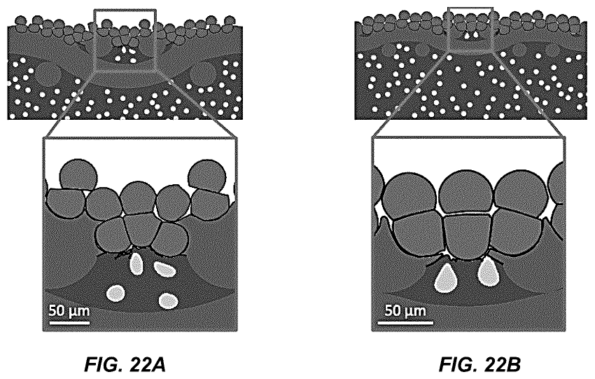

The effect of opening ratio on mechanical interlocking was also demonstrated in multiple particle simulations shown in FIGS. 22A and 22B. The depth and content of powder embedment resembled the observations shown in FIGS. 21A through 21D. Under the same impact conditions, Ti powder penetrated more deeply into the opening of BL120 than BL200. In simulations, 1500 ns after impact, the residual stress generated in the Al wire exceeded the stress generated in the epoxy film adhesive. The stress distribution of both BL120 and BL200 indicated that the impact loads were transmitted primarily to the Al wire, mitigating the extent of epoxy erosion.

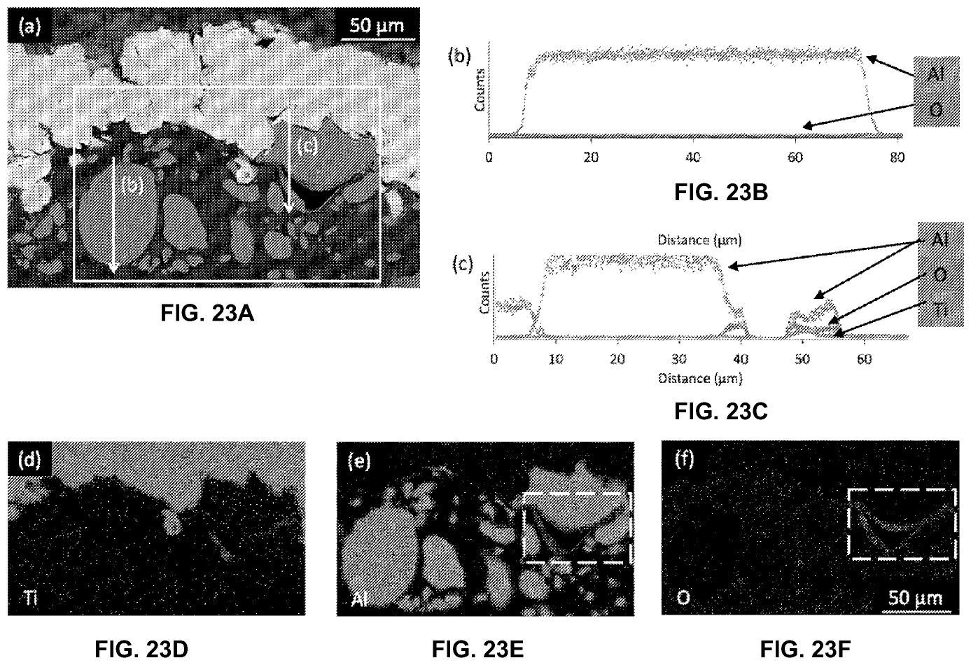

BL200 dissipated heat less effectively than BL120 because of the thinner wires of the mesh, and this led to wire oxidation. FIGS. 23A to 23F show that the thin metal layer that detached from the BL200 wire was oxidized Al (see EDS line scans of FIGS. 23B to 23C and composition maps of FIGS. 23D, 23E, and 23F). Only the wire nearer the surface interacted with LTS-Ti and separated from the film adhesive with part of the wire still attached to the film adhesive as shown in FIG. 23A which is a BSE micrograph of BL200 with EDS. FIGS. 23B to 23F reveal that oxidation only occurred when CP Ti interacted with wires directly, and negligible oxygen content was detected in the embedded wire. The consequence of load transfer between Al wire and epoxy resembles the direct impact of LTS powder onto substrates. The separation between Al wires and epoxy was attributed to CTE mismatch and rebound kinetic energy after impact. Rebound of LTS powder has resulted in partial detachment and gap formation between the LTS powder and the substrate. Oxides have also been observed at the LTS deposit-substrate interface. Both FIGS. 21A to 21D and FIGS. 23A to 23F evidence that the wire diameter affected heat dissipation during LTS deposition, and that metal substrate temperature decreases with increasing substrate thickness.

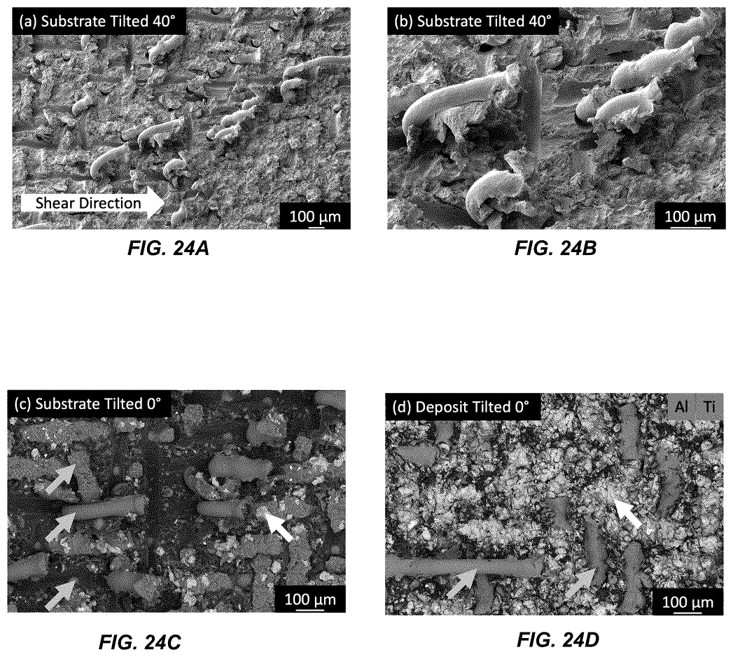

Shear strength measurements of BL200 (36.0±3.0 MPa) revealed insights into the role of the wire mesh in adhesion, and provided context for assessing the suitability of the bond layer approach in practice. FIGS. 24A to 24D show mixed mode failure between the CP Ti deposit and BL200 after shear tests. FIGS. 24A to 24B show regions of detached mesh, and bending and fracture of mesh wires on the substrate fracture surface. FIG. 24C shows sparsely dispersed Ti powder (lighter arrows) that remained on the substrate fracture surface. FIG. 24D shows detachment of Al wires (darker arrows) and Ti deposit (lighter arrows). Regions of the Ti deposit were interlocked with the film adhesive (dark grey), which was mixed with Al filler particles (darker arrows). The mixed failure mode indicated gradual crack propagation, and the failure mode undoubtedly contributed to fracture toughness. Both phenomena were dictated by the design of the hybrid bond layer.

In aerospace applications, the effectiveness of leading-edge protection by a metallic surface layer relies on the adhesion of the surface treatment as well as erosion mitigation in service. Poor adhesion even in a relatively small area can lead to entire debonding of leading-edge tapes. Erosion of leading edges can create surface asperities and trigger propagation of shear stress waves from the damage initiation site. In the second example, the measured shear strength exceeded the overlap shear strength of a structural adhesive used for aircraft maintenance and attaching leading-edge protection (33.8 MPa, Scotch-Weld AF 191 Film Adhesive. The hybrid bond layer of the second example also provided interlocking features that served as crack arresters at the deposit-substrate interface. With further refinement of BL designs, aspects of the second example can be fully automated for both consistent application and rapid restoration of adherent leading-edge protection.

In the second example, the effectiveness was demonstrated as to the hybrid bond layer being used for LTS deposition onto the CFRP. The mesh opening ratio (mesh opening size-to-powder diameter) determined the extent to which cold-sprayed powder mechanically interlocked and/or eroded epoxy exposed at mesh openings. Larger openings led to erosion of exposed adhesive, while smaller openings led to insufficient interlocking. The findings further indicated that as a general rule, mesh openings >10× the mean powder diameter or <1× the mean powder diameter are unlikely to result in acceptable mechanical interlocks for a continuous coating.

The design of the hybrid bond layer in conjunction with selection of powder diameter were major factors that controlled the microstructure of Ti deposits on CFRP. By incorporating an appropriately designed hybrid bond layer, low-temperature metal spray depositioned titanium, and Ti-6A1-4V, can be bonded to CFRP without adhesives. The process may be suitable for metallization in numerous contexts, including but not limited to leading edges in air vehicles and of bearing surfaces in medical implants. The findings demonstrate an approach to expand applications of LTS Ti alloys in protective coatings that can be restored, as well as in direct additive manufacturing onto composites.

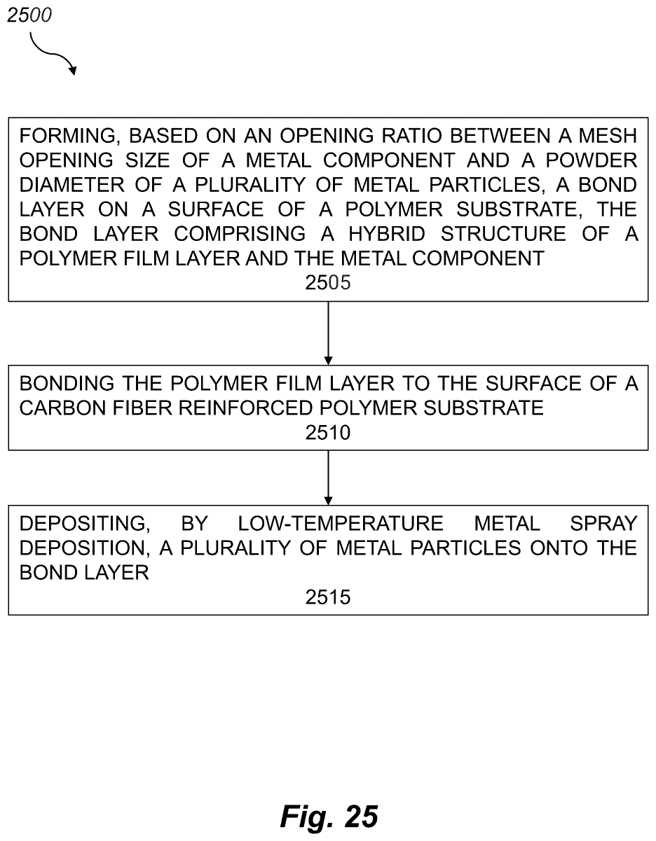

FIG. 25 is a flow chart of an exemplary method 2500 to form a metallized polymer substrate. In method 2500, step 2505 can include forming, based on an opening ratio between a mesh opening size of a metal component and a powder diameter of a plurality of metal particles, a bond layer on a surface of a polymer substrate, the bond layer comprising a hybrid structure of a polymer film layer and the metal component. Step 2510 of the method 2500 can include bonding the polymer film layer to the surface of a carbon fiber reinforced polymer substrate. Step 2515 of the method 2500 can include depositing, by low-temperature metal spray deposition, a plurality of metal particles onto the bond layer.

In some aspects, the step 2505 of forming the bond layer can include selecting the polymer film layer (which may not include a metal filler) and the metal component based on an opening ratio between a mesh opening size of the metal component and a powder diameter of the plurality of metal particles. In some aspects, the opening ratio is defined by the mesh opening size being less than approximately ten times a mean powder diameter of the powder diameter of the plurality of metal particles.

In some aspects, the step 2505 of forming the bond layer can include selecting the polymer film layer and the metal component based on a diameter ratio of a wire diameter of the metal component and a powder diameter of the plurality of metal particles.

In some aspects, during the step 2505 of forming the bond layer, a wire component of the metal component is partially disposed or embedded in the polymeric film layer such that a portion of the wire component remains exposed above a surface of the polymeric film layer. In some aspects, the step 2515 of depositing the plurality of metal particles onto the bond layer includes absorbing, by woven wires of the metal component, impact energy thereby reducing fracture or degradation of the polymer film layer.

Although systems and methods have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-25 may be modified, and that the foregoing discussion of certain of these embodiments does not necessarily represent a complete description of all possible embodiments. For example, one or more of the procedures, processes, or activities of FIG. 25 may include different procedures, processes, and/or activities and be performed by some different modules, in some different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

The herein disclosed systems and methods include hybrid bond layers for use in low-temperature metal spray deposition metallization of thermoset composites as well as bond layer suitability depended primarily on form (isolated vs continuous) and shape (curved vs flat) of the metal component. In some aspects, low-temperature metal spray deposition onto bond layers can impart metal-like durability, extend service life, facilitate restoration of the underlying CFRP. In some aspects, the herein disclosed systems and methods include bond layers that can be tailored to intended applications and engineered to join different classes of materials for components that face disparate service conditions

The specific configurations, choice of materials and the size and shape of various elements can be varied according to particular design specifications or constraints requiring a system or method constructed according to the principles of the disclosed technology. Such changes are intended to be embraced within the scope of the disclosed technology. The presently disclosed embodiments, therefore, are considered in all respects to be illustrative and not restrictive. It will therefore be apparent from the foregoing that while particular forms of the disclosure have been illustrated and described, various modifications can be made without departing from the spirit and scope of the disclosure and all changes that come within the meaning and range of equivalents thereof are intended to be embraced therein.

What is claimed is:

1. A metallized polymer substrate, comprising:
a polymer substrate having a surface;
a bond layer disposed on the polymer substrate surface, the bond layer a hybrid structure comprising a polymer component and a metal mesh layer; and
a metal layer disposed on the bond layer.

2. The metallized polymer substrate of claim 1, wherein the polymer substrate is a carbon fiber reinforced polymer.

3. The metallized polymer substrate of claim 1, wherein the polymer component is in the form of a polymer film that is disposed over the surface of the polymer substrate, wherein the polymer film layer is homogenous and the metal component is disposed over and in contact with the polymer film.

4. The metallized polymer substrate of claim 1, wherein the polymer component is in the form of a polymer film that is disposed over the surface of the polymer substrate, wherein the metal layer comprises metal particles disposed in the polymer film and on the bond layer wire mesh, wherein the metal particles comprise low-temperature metal spray depositioned Titanium particles and the metal mesh layer comprises aluminum.

5. A metallized polymer substrate comprising:
a carbon fiber reinforced polymer substrate having a surface;
a bond layer disposed on the polymer substrate surface, the bond layer comprising a hybrid structure of a polymer film layer and a metal component, wherein the polymer film layer is bonded to the surface of the carbon fiber reinforced polymer substrate, and wherein the metal component is disposed on and bonded with the polymer film layer; and
a metal particles forming a metallized layer on the bond layer.

6. The metallized polymer substrate of claim 5, wherein the bond layer polymer film layer comprises a metal filler.

7. The metallized polymer substrate of claim 5, wherein the metal component is woven wire mesh and the bond layer polymer film layer does not contain a metal filler.

8. The metallized polymer substrate of claim 7, wherein the woven wire mesh is disposed over an entirety of the bond layer polymer film layer.

9. The metallized polymer substrate of claim 7, wherein the woven wire mesh is disposed a partial depth into the bond layer polymer film layer such that a portion of the woven wire mesh is exposed a distance above a surface of the polymer film layer.

10. The metallized polymer substrate of claim 5, wherein the metal particles of the metallized layer are disposed in the bond layer polymer film layer and/or the bond layer metal component, wherein the metal particles comprise low-temperature metal spray depositioned Titanium particles.

11. A method for forming a metallized polymer substrate comprising the steps of:
forming, based on an opening ratio between a mesh opening size of a metal component and a powder diameter of a plurality of metal particles, a bond layer on a surface of a polymer substrate, the bond layer comprising a hybrid structure of a polymer film layer and the metal component;
bonding the polymer film layer to the surface of a carbon fiber reinforced polymer substrate; and
depositing, by low-temperature metal spray deposition, the plurality of metal particles onto the bond layer.

12. The method of claim 11, wherein the opening ratio is less than or equal to approximately 1.7.

13. The method of claim 11, wherein the opening ratio ranges between approximately 1 to 3.

14. The method of claim 11, wherein the opening ratio is defined by the mesh opening size being less than approximately ten times a mean powder diameter of the powder diameter of the plurality of metal particles.

15. The method of claim 11, wherein the step of forming the bond layer comprises selecting the polymer film layer and the metal component based on a diameter ratio of a powder diameter of the plurality of metal particles and a wire diameter of the metal component.

16. The method of claim 11, wherein the step of forming the bond layer comprises selecting the polymer film layer and the metal component based on a ratio of a powder diameter of the plurality of metal particles and a mesh opening diameter of the metal component.

17. The method of claim 11, wherein during the step of forming the bond layer, the polymer film layer is disposed on the surface of the carbon fiber reinforced polymer substrate, the metal component being disposed on the surface of the polymer film, and the bond layer is subjected to a curing operation.

18. The method of claim 11, wherein during the step of forming the bond layer, a wire component of the metal component is partially disposed or embedded in the polymeric film layer such that a portion of the wire component remains exposed above a surface of the polymeric film layer.

19. The method of claim 11, wherein the step of depositing the plurality of metal particles onto the bond layer comprises absorbing, by woven wires of the metal component, impact energy thereby reducing fracture or degradation of the polymer film layer.

20. The method of claim 11, wherein during the step of depositing, the metal particles applied by low-temperature metal spray deposition are disposed into the polymer film layer.
